(19) United States
(12) Patent Application Publication
(10) Pub. No.: US 2014/0177946 A1
(43) Pub. Date: Jun. 26, 2014

(54) HUMAN DETECTION APPARATUS AND METHOD

(71) Applicant: Electronics and Telecommunications Research Institute, Daejeon-city (KR)

(72) Inventors: Kil-Taek LIM, Daegu (KR); Yun-Su CHUNG, Daejeon (KR); Byung-Gil HAN, Daegu (KR); Eun-Chang CHOI, Daejeon (KR); Soo-In LEE, Daejeon (KR)

(73) Assignee: Electronics and Telecommunicatidons Research Institute, Daejeon-city (KR)

(21) Appl. No.: 13/959,310

(22) Filed: Aug. 5, 2013

(30) Foreign Application Priority Data
Dec. 21, 2012 (KR) 10-2012-0150808

(51) Int. Cl. G06K 9/00

(52) U.S. Cl. CPC G06K 9/00369
USPC 382/156

(57) ABSTRACT

Disclosed herein is an apparatus and method for detecting a person from an input video image with high reliability by using gradient-based feature vectors and a neural network. The human detection apparatus includes an image preprocessing unit for modeling a background image from an input image. A moving object area setting unit sets a moving object area in which motion is present by obtaining a difference between the input image and the background image. A human region detection unit extracts gradient-based feature vectors for a whole body and an upper body from the moving object area, and detects a human region in which a person is present by using the gradient-based feature vectors for the whole body and the upper body as input of a neural network classifier. A decision unit decides whether an object in the detected human region is a person or a non-person.

### CROSS REFERENCE TO RELATED APPLICATION

This application claims the benefit of Korean Patent Application No. 10-2012-0150808 filed on Dec. 21, 2012, which is hereby incorporated by reference in its entirety into this application.

### BACKGROUND OF THE INVENTION

1. Technical Field

The present invention relates generally to a human detection apparatus and method and, more particularly, to a human detection apparatus and method that can determine, with high reliability, whether a person is present in a motion area of a video image.

2. Description of the Related Art

In the field of security and crime prevention, the function of automatically analyzing video images acquired using a video sensor, such as a Closed Circuit Television (CCTV), in real time and detecting an intruder is required.

Systems currently used in security and crime prevention fields manage images input from cameras while a system operator is monitoring the images with the naked eye, thus deteriorating performance from the standpoint of cost and efficiency.

In some systems equipped with a human detection function, when a person is detected, the attention of a system operator is attracted using an alarm or the like so that he or she can deal with a current situation. In this case, there may frequently occur a case where a false alarm occurs or where an intruder is not detected. This corresponds to a case where the detection of motion is abnormally performed and a detected object is falsely recognized as a person, or a case where the detection of motion is normally performed, but a person is falsely detected.

Korean Patent No. 10-0543706 (entitled “Vision-based human detection method and apparatus”) discloses technology for accurately and rapidly detecting the location of a person using skin color information and shape information from an input image. The invention disclosed in Korean Patent No. 10-0543706 includes the step of detecting one or more skin color areas, using skin color information, from a frame image that has been captured and input; the step of determining whether each skin color area corresponds to a human candidate area; and the step of determining whether each skin color area determined to be the human candidate area corresponds to a person, based on the shape information of a person.

The invention disclosed in Korean Patent No. 10-0543706 uses skin color information to detect a human region. A method using a skin color in this way cannot be applied to a system that is incapable of providing color information. Further, if color information is remarkably varied depending on a variation in illumination even when color information is provided, performance is greatly deteriorated.

Meanwhile, one of the other main causes of errors in human detection is a case where the amount of feature information used to classify images is insufficient. Korean Patent No. 10-1077312 (entitled “Human detection apparatus and method using Haar-like features”) discloses technology for automatically detecting the presence of an object of interest in real time using Haar-like features, and tracking the object of interest, thus actively replacing the role of a person. The invention disclosed in Korean Patent No. 10-1077312 includes a preprocessing unit for smoothing an input image so that it is not sensitive to illumination and external environments, a candidate area determination unit for extracting features from the input image using an AdaBoost learning algorithm based on Haar-like features, comparing the extracted features with candidate area features stored in a candidate area feature database, and then determining a candidate area, and an object determination unit for determining an object based on the candidate area determined by the candidate area determination unit.

In this way, the Haar-like features (used by Violar et al. in 2001) most commonly used for face detection can provide information sufficient for detection when image characteristics relatively stand out as in the case of a face, but power of expression is not sufficient upon detecting a person who appears remarkably different depending on various types of clothes, manners of walking, viewpoints, etc.

### SUMMARY OF THE INVENTION

Accordingly, the present invention has been made keeping in mind the above problems occurring in the prior art, and an object of the present invention is to provide an apparatus and method for detecting a person from an input video image with high reliability by using gradient-based feature vectors and a neural network.

In accordance with an aspect of the present invention to accomplish the above object, there is provided a human detection apparatus including an image preprocessing unit for modeling a background image from an input image; a moving object area setting unit for setting a moving object area in which motion is present by obtaining a difference between the input image and the background image; a human region detection unit for extracting gradient-based feature vectors for a whole body and an upper body from the moving object area, and detecting a human region in which a person is present by using the gradient-based feature vectors for the whole body and the upper body as input of a neural network classifier; and a decision unit for deciding whether an object in the detected human region is a person or a non-person.

Preferably, the human region detection unit may include a gradient map generation unit for converting an image in the moving object area into a gradient map; a normalized gradient map generation unit for normalizing the gradient map; and a determination unit for extracting feature vectors for a whole body and an upper body of a person from the normalized gradient map generated by the normalized gradient map generation unit, and determining the human region based on the feature vectors.

Preferably, the determination unit may include a feature vector extraction unit for applying a search window to the normalized gradient map, and individually extracting the feature vectors for the whole body and the upper body of the person from respective locations of a scanned search window while scanning the search window; and a classification unit for generating detection scores for the respective locations of the search window by using the feature vectors for the whole body and the upper body of the person extracted from the respective locations of the search window as the input of the neural network classifier, and determining a location of the search window having a highest detection score to be a region in which a person is present.

Preferably, the classification unit may set a sum of a whole body detection score and an upper body detection score generated for each location of the search window as a detection score of a corresponding location of the search window.

Preferably, the neural network classifier may include a whole body neural network classifier and an upper body neural network classifier, and the classification unit may use feature vectors for the whole body of the person extracted from the respective locations of the search window as input of the whole body neural network classifier and use feature vectors for the upper body of the person extracted from the respective locations of the search window as input of the upper body neural network classifier.

Preferably, the decision unit may include a final neural network classifier for receiving the whole body neural network feature vectors from the whole body neural network classifier and the upper body neural network feature vectors from the upper body neural network classifier as input.

Preferably, the decision unit may finally decide that a person has been detected if a difference between an output value of an output node corresponding to a person and an output value of an output node corresponding to a non-person in the final neural network classifier exceeds a threshold value.

In accordance with another aspect of the present invention to accomplish the above object, there is provided a human detection method including modeling, by an image preprocessing unit, a background image from an input image; setting, by a moving object area setting unit, a moving object area in which motion is present by obtaining a difference between the input image and the background image; extracting, by a human region detection unit, gradient-based feature vectors for a whole body and an upper body from the moving object area; detecting, by the human region detection unit, a human region in which a person is present by using the gradient-based feature vectors for the whole body and the upper body as input of a neural network classifier; and deciding, by a decision unit, whether an object in the detected human region is a person or a non-person.

Preferably, extracting the feature vectors may include converting an image in the moving object area into a gradient map; normalizing the gradient map; and extracting the feature vectors for the whole body and the upper body of the person from the normalized gradient map.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of a human detection apparatus according to an embodiment of the present invention;

FIG. 2 is a diagram showing the internal configuration of a human region detection unit shown in FIG. 1;

FIG. 3 is a diagram showing the internal configuration of a determination unit shown in FIG. 2;

FIG. 4 is a diagram used to describe a procedure for searching an entire map for a location at which a person is present according to an embodiment of the present invention;

FIG. 5 is a diagram used to describe a feature vector extraction procedure according to an embodiment of the present invention;

FIGS. 6 and 7 are diagrams showing examples of a neural network classifier employed in a classification unit shown in FIG. 3; and

FIG. 8 is a diagram showing an example of a neural network classifier employed in a decision unit shown in FIG. 1.

### DESCRIPTION OF THE PREFERRED EMBODIMENTS

Hereinafter, a human detection apparatus and method according to embodiments of the present invention will be described in detail with reference to the attached drawings. Prior to the detailed description of the present invention, it should be noted that the terms or words used in the present specification and the accompanying claims should not be limitedly interpreted as having their common meanings or those found in dictionaries. Therefore, the embodiments described in the present specification and constructions shown in the drawings are only the most preferable embodiments of the present invention, and are not representative of the entire technical spirit of the present invention. Accordingly, it should be understood that various equivalents and modifications capable of replacing the embodiments and constructions of the present invention might be present at the time at which the present invention was filed.

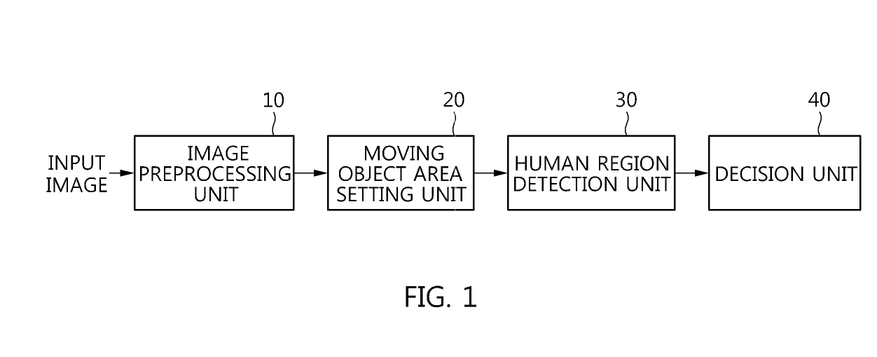

FIG. 1 is a diagram showing the configuration of a human detection apparatus according to an embodiment of the present invention.

The human detection apparatus according to the embodiment of the present invention includes an image preprocessing unit 10, a moving object area setting unit 20, a human region detection unit 30, and a decision unit 40.

The image preprocessing unit 10 performs the function of modeling a background image from an image input from a camera and eliminating noise from the image. The background image generated by the image preprocessing unit 10 and the input image are input to the moving object area setting unit 20.

The moving object area setting unit 20 detects an area in which motion is present by obtaining a difference between the input image and the background image. That is, the moving object area setting unit 20 eliminates the background image from the input image received from the image preprocessing unit 10, sets an image area determined to be an area of a moving object in a background-eliminated image, and sends the set image area to the human region detection unit 30.

The human region detection unit 30 detects a region, in which an actual person is present (that is, a human region), from the image area determined to be the area of a moving object (hereinafter referred to as a ‘moving object area’) and provided by the moving object area setting unit 20. Preferably, the human region detection unit 30 uses gradient-based feature vectors and a neural network classifier. The internal configuration of the human region detection unit 30 will be described later.

If the human region has been detected by the human region detection unit 30, the decision unit 40 finally decides whether an object in the region is a person or a non-person. Preferably, the decision unit 40 is implemented using a neural network classifier.

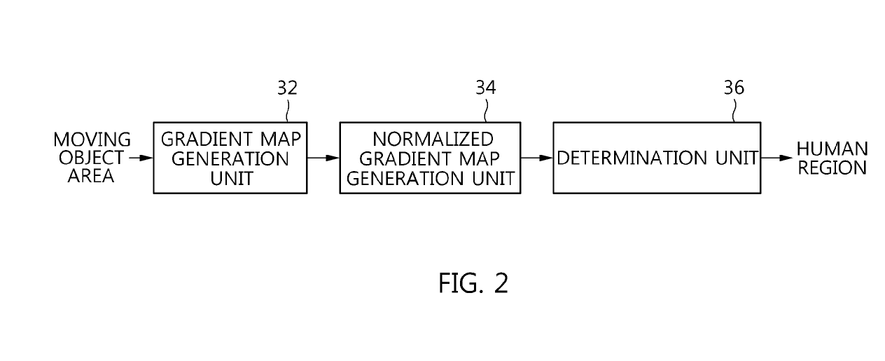

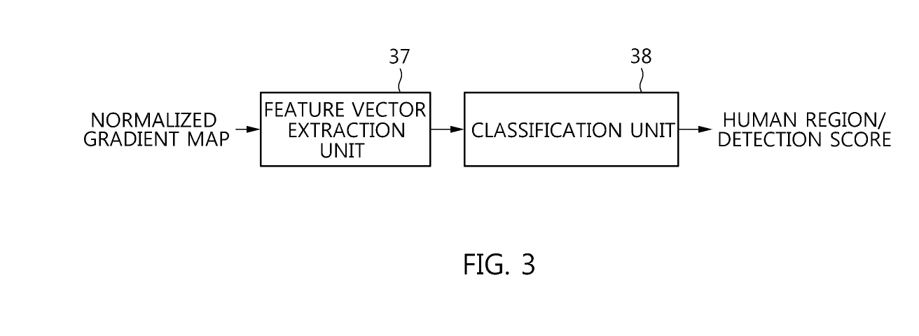

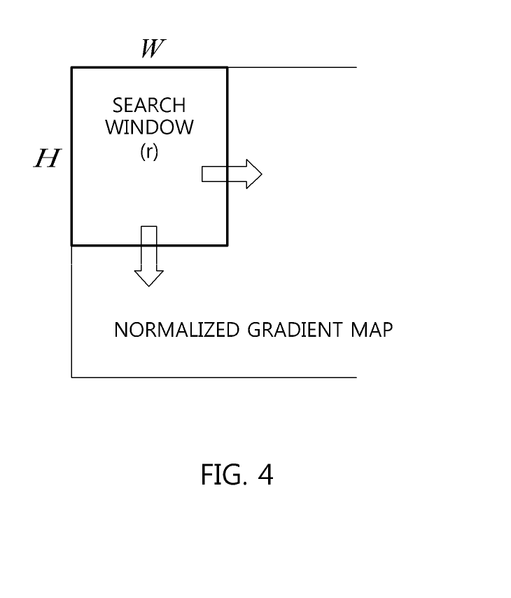

FIG. 2 is a diagram showing the internal configuration of the human region detection unit shown in FIG. 1, FIG. 3 is a diagram showing the internal configuration of the determination unit shown in FIG. 2, and FIG. 4 is a diagram used to describe a procedure for searching an entire map for a location at which a person is present according to an embodiment of the present invention.

The human region detection unit 30 includes a gradient map generation unit 32, a normalized gradient map generation unit 34, and a determination unit 36.

The gradient map generation unit 32 converts an image f(x, y) present in a moving object area into a gradient map G(x, y) using the following Equation (1):

In the following Equation (1), G(x, y) is a gradient map that can be obtained by applying various gradient operators, such as a Sobel or Prewitt operator, to the image f(x, y). G(x, y) is composed of a magnitude M(x, y) and a direction α(x, y).

$$G ( x , y ) = {[ {g}_{x} ( x , y ) , {g}_{y} ( x , y ) ]}^{T} , \\ G ( x , y ) = M ( x , y ) ∠α ( x , y ) \\ M ( x , y ) = \sqrt{{g}_{x}^{2} ( x , y ) + {g}_{y}^{2} ( x , y )} \\ α ( x , y ) = a tan 2 [ {g}_{y} ( x , y ) , {g}_{x} ( x , y ) ] \\ {g}_{x} ( x , y ) = \frac{\partial f ( x , y )}{\partial x} , \\ {g}_{y} ( x , y ) = \frac{\partial f ( x , y )}{\partial y} \qquad ( 1 )$$

where G(x, y) denotes a gradient map at a location (x,y), M(x, y) denotes a magnitude value at the location (x,y), α(x, y) denotes a direction value at the location (x,y), gₓ(x, y) denotes the partial differential value of the image f(x, y) in an x direction, g_{y}(x, y) denotes the partial differential value of the image f(x, y) in a y direction, and T denotes a transposed vector.

The normalized gradient map generation unit 34 normalizes the gradient map generated by the gradient map generation unit 32. The following Equation (2) shows an equation for calculating a normalized gradient map N(x, y).

$$N ( x , y ) = NM ( x , y ) ∠α ( x , y ) \\ NM ( x , y ) = \frac{( M ( x , y ) - {M}_{min} ) ( {NM}_{max} - {NM}_{min} )}{{M}_{max} - {M}_{min}} + {NM}_{min} \qquad ( 2 )$$

where N(x, y) denotes a normalized gradient map at the location (x,y), Mₘᵢₙ denotes the minimum magnitude value of the gradient map, Mₘₐₓ denotes the maximum magnitude value of the gradient map, M(x, y) denotes a magnitude value at the location (x,y), NMₘᵢₙ denotes the minimum magnitude value of a preset normalized gradient map, NMₘₐₓ denotes the maximum magnitude value of the preset normalized gradient map, NM(x, y) denotes a normalized magnitude value at the location (x,y), and α(x, y) denotes a direction value at the location (x,y).

The determination unit 36 determines whether the whole body or the upper body of a person is detected in the normalized gradient map extracted from the moving object area. For this operation, the determination unit 36 individually extracts feature vectors for the whole body and the upper body through the feature vector extraction unit 37 of FIG. 3, transmits the feature vectors to the classification unit 38, and then enables a human region and detection scores to be generated. In order to search the entire map for a location at which a person is present, a search window (r) is overlaid on the entire normalized gradient map, as shown in FIG. 4. The feature vector extraction unit 37 extracts feature vectors for the whole body and the upper body from respective locations of the search window (r) while raster scanning the search window (r) vertically and horizontally. The individual extracted feature vectors are input to a classifier provided in the classification unit 38. Accordingly, the classification unit 38 generates detection scores. The classification unit 38 determines the location of the search window having a highest detection score to be a region in which a person is present.

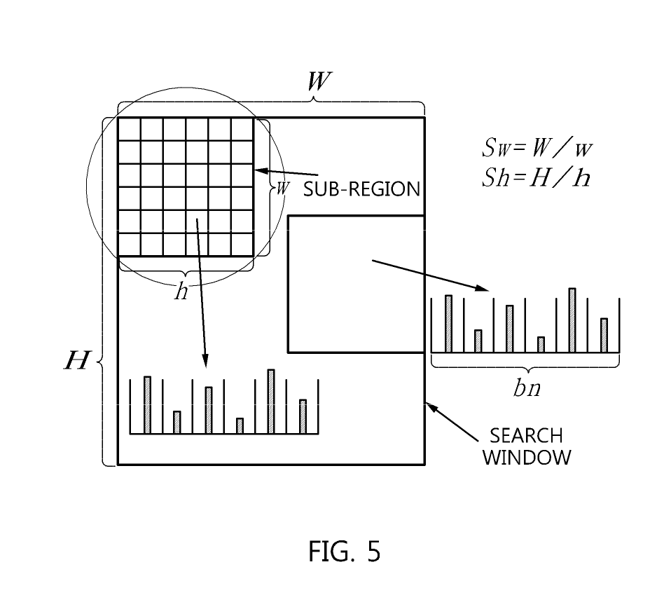

Hereinafter, the operations of the feature vector extraction unit 37 and the classification unit 38 will be described in detail with reference to FIGS. 5 to 7.

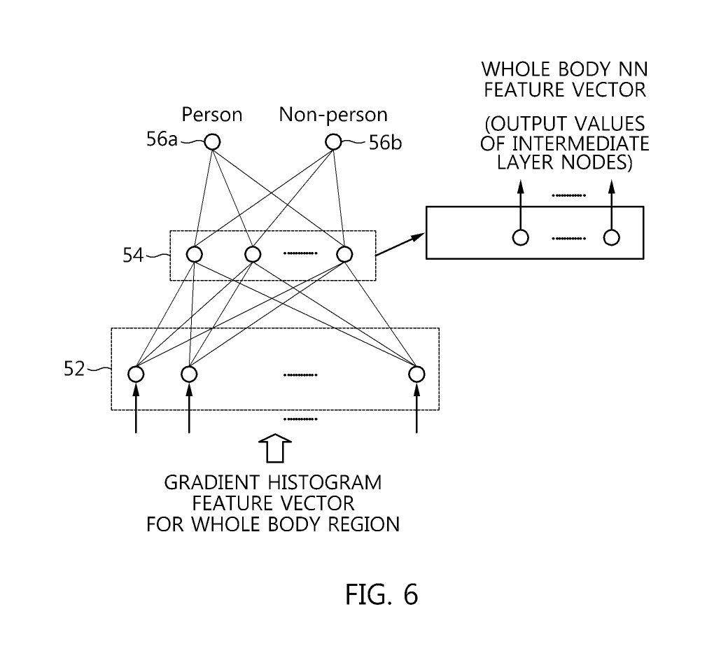

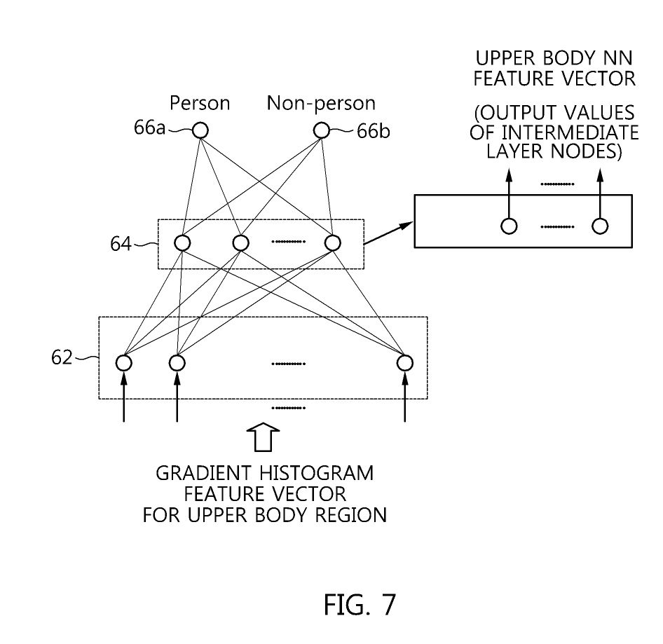

FIG. 5 is a diagram used to describe a feature vector extraction procedure according to an embodiment of the present invention, and FIGS. 6 and 7 are diagrams showing examples of a neural network classifier employed in the classification unit shown in FIG. 3.

The feature vector extraction procedure performed by the feature vector extraction unit 37 will be described in detail with reference to FIG. 5 and the following Equation (3).

A normalized gradient map within a search window having a W×H size is divided into S_{w}×Sₕ sub-regions (each sub-region is composed of w×h gradient components), bn bins determined by bw (bin-width) are allocated to each sub-region, and values of NM(x, y) are accumulated by applying direction α(x, y) to bins having index bₛ(i). The number of feature vectors present in each sub-region is S_{W}×S_{H}, and the feature vectors are connected, and thus a final feature vector having S_{W}×Sₕ×bn dimensions can be obtained.

S_{w}=W/w, Sₕ=H/h

bn=π/bw, bw−bin width, bin number

$${b}_{s} ( i ) = ⌊ \frac{\vert α ( x , y ) \vert}{bw} + 0.5 ⌋ \qquad ( 3 )$$

where bₛ(i) denotes a bin index in a sub-region s. Further, W denotes the lateral size (width) of the search window, H denotes the vertical size (height) of the search window, and w and h respectively denote the lateral size and the vertical size of each sub-region in the search window. S_{W} denotes a value obtained by dividing W by w, that is, the number of sub-regions present in the lateral direction within the search window. Sₕ denotes a value obtained by dividing H by h, that is, the number of sub-regions present in the vertical direction within the search window. Furthermore, bw denotes a value required to represent the direction of a gradient by a quantized code, and is a size by which the absolute value of the direction angle of a pixel gradient present in an interval from 0 to +π is divided into sections. Furthermore, bn denotes the number of sections obtained when the interval [0,π] is equally divided by a size of bw, and each section is called a bin.

A feature vector for an upper body is composed of features located in the upper half region of the search window. As described above, the region of an object image is extracted as gradient-based feature vectors, without being represented by simple image brightness values, thus more effectively discriminating between a person and a non-person.

Meanwhile, the classification unit 38 is composed of perceptron Neural Network (NN) classifiers, each having a single intermediate layer. A whole body NN classifier for extracting a whole body feature vector in the classification unit 38 is illustrated in FIG. 6. The whole body NN classifier illustrated in FIG. 6 includes an input layer 52 having a gradient histogram feature vector for a whole body region as input, an intermediate layer 54 having a plurality of nodes, and two nodes 56a and 56b corresponding to person/non-person. Further, an upper body NN classifier for extracting an upper body feature vector in the classification unit 38 is illustrated in FIG. 7. The upper body NN classifier illustrated in FIG. 7 includes an input layer 62 having a gradient histogram feature vector for an upper body region as an input, an intermediate layer 64 having a plurality of nodes, and two nodes 66a and 66b corresponding to person/non-person.

In the search window (r), a whole body detection score (GScore) is set as a difference between the output value Oₚ^{G} of the output node 56a corresponding to a person and the output value Oₙ^{G} of the output node 56b corresponding to a non-person in the output nodes of the whole body NN classifier of FIG. 6, as given by the following Equation (4).

An upper body detection score (UScore) is determined in the same manner as the above-described whole body detection score.

Accordingly, the detection score of the search window (r) is designated as the sum of the whole body detection score and the upper body detection score at the corresponding location of the search window. After the detection scores have been generated for all locations of the search window, if both a whole body and an upper body are detected at the location of the search window having a highest detection score, it can be determined that a person has been detected.

GScore(r)=Oₚ^{G}(r)−Oₙ^{G}(r)

UScore(r)=Oₚ^{U}(r)−Oₙ^{U}(r)

if GScore(r)>Thres, whole body detection success

if UScore(r)>Thres, upper body detection success

where Oₚ^{G}(r) denotes the output value of the output node corresponding to a person in the output nodes of the whole body NN classifier in the search window (r), Oₙ^{G}(r) denotes the output value of the output node corresponding to a non-person in the output nodes of the whole body NN classifier in the search window(r), Oₚ^{U}(r) denotes the output value of the output node corresponding to a person in the output nodes of the upper body NN classifier in the search window (r), Oₙ^{U}(r) denotes the output value of the output node corresponding to a non-person in the output nodes of the upper body NN classifier in the search window(r), and Thres denotes a threshold value.

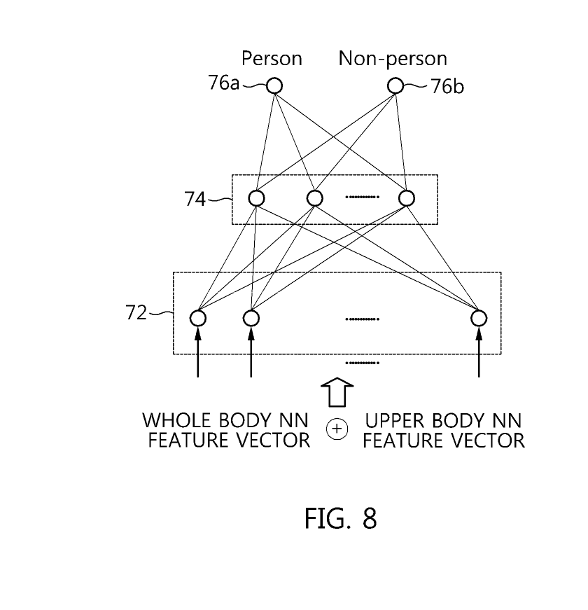

If either of a whole body and an upper body is not detected at the location of the search window having the highest detection score (that is, if decisions made by the whole body NN classifier and the upper body NN classifier are different from each other), the decision unit 40 implemented as a final NN classifier illustrated in FIG. 8 finally decides whether the object is a person or a non-person.

FIG. 8 is a diagram showing an example of the NN classifier employed in the decision unit shown in FIG. 1.

The decision unit 40 is implemented as a final NN classifier illustrated in FIG. 8. The final NN classifier receives, as input, a whole body NN feature vector composed of the output values of the intermediate layer nodes of the whole body NN classifier and an upper body NN feature vector composed of the output values of the intermediate layer nodes of the upper body NN classifier. The final NN classifier of FIG. 8 includes an input layer 72, an intermediate layer 74 composed of a plurality of nodes, and two nodes 76a and 76b corresponding to person/non-person. The final NN classifier finally decides that a person has been detected if a difference between the output value Oₚ^{F} of the output node 76a corresponding to a person and the output value Oₙ^{F} of the output node 76b corresponding to a non-person exceeds a threshold.

In accordance with the present invention having the above configuration, it can be automatically determined whether a person is present in a plurality of moving object areas extracted from a video image acquired by a camera using a background area modeling technique.

The present invention is applied to a CCTV video monitoring system or the like, and then an automatic human detection function for security and crime prevention can be effectively realized.

Further, since CCTV video monitoring cameras are installed in various places and in various manners, various images can be acquired. The present invention uses gradient-based feature vectors and neural networks for a whole body and an upper body, which have excellent discernment capability, even for various types of images, thus enabling human detection to be performed with high reliability.

Meanwhile, the present invention is not limited by the above embodiments, and various changes and modifications can be implemented without departing from the scope and spirit of the invention. It should be understood that the technical spirit of the changes and modifications also belongs to the scope of the accompanying claims.

What is claimed is:

1. A human detection apparatus comprising:
an image preprocessing unit for modeling a background image from an input image;
a moving object area setting unit for setting a moving object area in which motion is present by obtaining a difference between the input image and the background image;
a human region detection unit for extracting gradient-based feature vectors for a whole body and an upper body from the moving object area, and detecting a human region in which a person is present by using the gradient-based feature vectors for the whole body and the upper body as input of a neural network classifier; and
a decision unit for deciding whether an object in the detected human region is a person or a non-person.

2. The human detection apparatus of claim 1, wherein the human region detection unit comprises:
a gradient map generation unit for converting an image in the moving object area into a gradient map;
a normalized gradient map generation unit for normalizing the gradient map; and
a determination unit for extracting feature vectors for a whole body and an upper body of a person from the normalized gradient map generated by the normalized gradient map generation unit, and determining the human region based on the feature vectors.

3. The human detection apparatus of claim 2, wherein the gradient map generation unit generates the gradient map using the following Equation (1):
$$G ( x , y ) = {[ {g}_{x} ( x , y ) , {g}_{y} ( x , y ) ]}^{T} , \\ G ( x , y ) = M ( x , y ) ∠α ( x , y ) \\ M ( x , y ) = \sqrt{{g}_{x}^{2} ( x , y ) + {g}_{y}^{2} ( x , y )} \\ α ( x , y ) = a tan 2 [ {g}_{y} ( x , y ) , {g}_{x} ( x , y ) ] \\ {g}_{x} ( x , y ) = \frac{\partial f ( x , y )}{\partial x} , \\ {g}_{y} ( x , y ) = \frac{\partial f ( x , y )}{\partial y} \qquad ( 1 )$$
where G(x, y) denotes a gradient map at a location (x,y), M(x, y) denotes a magnitude value at the location (x,y), α(x, y) denotes a direction value at the location (x,y), gₓ(x, y) denotes a partial differential value of an image f(x, y) in an x direction, g_{y}(x, y) denotes a partial differential value of the image f(x, y) in a y direction, and T denotes a transposed vector.

4. The human detection apparatus of claim 2, wherein the normalized gradient map generation unit generates the normalized gradient map using the following Equation (2):
$$N ( x , y ) = NM ( x , y ) ∠α ( x , y ) \\ NM ( x , y ) = \frac{( M ( x , y ) - {M}_{min} ) ( {NM}_{max} - {NM}_{min} )}{{M}_{max} - {M}_{min}} + {NM}_{min} \qquad ( 2 )$$
where N(x, y) denotes a normalized gradient map at a location (x,y), Mₘᵢₙ denotes a minimum magnitude value of the gradient map, Mₘₐₓ denotes a maximum magnitude value of the gradient map, M(x, y) denotes a magnitude value at the location (x,y), NMₘᵢₙ denotes a minimum magnitude value of a preset normalized gradient map, NMₘₐₓ denotes a maximum magnitude value of the preset normalized gradient map, NM(x, y) denotes a normalized magnitude value at the location (x,y), and α(x, y) denotes a direction value at the location (x,y).

5. The human detection apparatus of claim 2, wherein the determination unit comprises:
a feature vector extraction unit for applying a search window to the normalized gradient map, and individually extracting the feature vectors for the whole body and the upper body of the person from respective locations of a scanned search window while scanning the search window; and
a classification unit for generating detection scores for the respective locations of the search window by using the feature vectors for the whole body and the upper body of the person extracted from the respective locations of the search window as the input of the neural network classifier, and determining a location of the search window having a highest detection score to be a region in which a person is present.

6. The human detection apparatus of claim 5, wherein the classification unit sets a sum of a whole body detection score and an upper body detection score generated for each location of the search window as a detection score of a corresponding location of the search window.

7. The human detection apparatus of claim 5, wherein:
the neural network classifier comprises a whole body neural network classifier and an upper body neural network classifier, and
the classification unit uses feature vectors for the whole body of the person extracted from the respective locations of the search window as input of the whole body neural network classifier, and uses feature vectors for the upper body of the person extracted from the respective locations of the search window as input of the upper body neural network classifier.

8. The human detection apparatus of claim 7, wherein the decision unit comprises a final neural network classifier for receiving the whole body neural network feature vectors from the whole body neural network classifier and the upper body neural network feature vectors from the upper body neural network classifier as input.

9. The human detection apparatus of claim 8, wherein the decision unit finally decides that a person has been detected if a difference between an output value of an output node corresponding to a person and an output value of an output node corresponding to a non-person in the final neural network classifier exceeds a threshold value.

10. A human detection method comprising:
modeling, by an image preprocessing unit, a background image from an input image;
setting, by a moving object area setting unit, a moving object area in which motion is present by obtaining a difference between the input image and the background image;
extracting, by a human region detection unit, gradient-based feature vectors for a whole body and an upper body from the moving object area;
detecting, by the human region detection unit, a human region in which a person is present by using the gradient-based feature vectors for the whole body and the upper body as input of a neural network classifier; and
deciding, by a decision unit, whether an object in the detected human region is a person or a non-person.

11. The human detection method of claim 10, wherein extracting the feature vectors comprises:
converting an image in the moving object area into a gradient map;
normalizing the gradient map; and
extracting the feature vectors for the whole body and the upper body of the person from the normalized gradient map.

12. The human detection method of claim 11, wherein the gradient map is generated by the following Equation (1):
$$G ( x , y ) = {[ {g}_{x} ( x , y ) , {g}_{y} ( x , y ) ]}^{T} , \\ G ( x , y ) = M ( x , y ) ∠α ( x , y ) \\ M ( x , y ) = \sqrt{{g}_{x}^{2} ( x , y ) + {g}_{y}^{2} ( x , y )} \\ α ( x , y ) = a tan 2 [ {g}_{y} ( x , y ) , {g}_{x} ( x , y ) ] \\ {g}_{x} ( x , y ) = \frac{\partial f ( x , y )}{\partial x} , \\ {g}_{y} ( x , y ) = \frac{\partial f ( x , y )}{\partial y} \qquad ( 1 )$$
where G(x, y) denotes a gradient map at a location (x,y), M(x, y) denotes a magnitude value at the location (x,y), α(x, y) denotes a direction value at the location (x,y), gₓ(x, y) denotes a partial differential value of an image f(x, y) in an x direction, g_{y}(x, y) denotes a partial differential value of the image f(x, y) in a y direction, and T denotes a transposed vector.

13. The human detection method of claim 11, wherein the normalized gradient map is generated by the following Equation (2):
$$N ( x , y ) = NM ( x , y ) ∠α ( x , y ) \\ NM ( x , y ) = \frac{( M ( x , y ) - {M}_{min} ) ( {NM}_{max} - {NM}_{min} )}{{M}_{max} - {M}_{min}} + {NM}_{min} \qquad ( 2 )$$
where N(x, y) denotes a normalized gradient map at a location (x,y), Mₘᵢₙ denotes a minimum magnitude value of the gradient map, Mₘₐₓ denotes a maximum magnitude value of the gradient map, M(x, y) denotes a magnitude value at the location (x,y), NMₘᵢₙ denotes a minimum magnitude value of a preset normalized gradient map, NMₘₐₓ denotes a maximum magnitude value of the preset normalized gradient map, NM(x, y) denotes a normalized magnitude value at the location (x,y), and α(x, y) denotes a direction value at the location (x,y).
